(19) United States
(12) Patent Application Publication
(10) Pub. No.: US 2025/0227177 A1
(43) Pub. Date: Jul. 10, 2025

(54) PRESENTING SUMMARY OF COMMUNICATION

(71) Applicant: GOOGLE LLC, Mountain View, CA (US)

(72) Inventors: Rashi Karanpuria, Kitchener (CA); Susan Qi Xu, San Francisco, CA (US); Vikas Bahirwani, San Francisco, CA (US); Nooshin Mojab, New York, NY (US); Zeina Oweis, San Francisco, CA (US); Emma Gardiner, New York, NY (US); Andrea Colaco, Los Altos, CA (US); Lee Payne, Waterloo (CA); Lin Li, Sunnyvale, CA (US); Brent Bisaillion, Kitchener (CA); Alex Olwal, Santa Cruz, CA (US); Bhanu Prakash Reddy Guda, Sunnyvale, CA (US)

(21) Appl. No.: 19/011,359

(22) Filed: Jan. 6, 2025

Related U.S. Application Data
(60) Provisional application No. 63/618,141, filed on Jan. 5, 2024.
(60) Provisional application No. 63/726,837, filed on Dec. 2, 2024.

(51) Int. Cl. H04M 1/72436; H04L 51/043; H04L 51/046; H04L 51/063; H04M 1/72409

(52) U.S. Cl. CPC H04M 1/72436; H04L 51/043; H04L 51/046; H04L 51/063; H04M 1/724094

(57) ABSTRACT

A method can include receiving a message associated with a user account; determining a priority based on content of the message; determining a first status associated with the user account; based on the priority and the first status, withholding notification of the message; determining a second status associated with the user account; and based on the priority and the second status, presenting a summary of the message.

### PRIORITY CLAIM

This application claims the benefit of priority to U.S. Provisional Application No. 63/618,141, filed on Jan. 5, 2024, and U.S. Provisional Application No. 63/726,837, filed on Dec. 2, 2024, the disclosures of which are hereby incorporated by reference.

### BACKGROUND

Devices can receive multiple messages. Presenting notifications of the messages can be distracting to a user. Devices with limited display areas may also have difficulty presenting content of the messages.

### SUMMARY

A system can determine a priority level of a message received, which can indicate how important or urgent the message is. The system can also determine a status associated with a user account that received the message. The status can indicate a focused activity such as driving, during which messages should not be received, or a relatively low-concentration activity such as walking when a message can be safely received. Based on the priority level and status, the system can determine whether to withhold a notification of the message or present a summary of the message. The summary can include fewer words or characters than the original message, enabling the summary to be presented on a small display such as a display included in a wearable device.

A method can include receiving a message associated with a user account; determining a priority based on content of the message; determining a first status associated with the user account; based on the priority and the first status, withholding notification of the message; determining a second status associated with the user account; and based on the priority and the second status, presenting a summary of the message.

A non-transitory computer-readable storage medium can include instructions stored thereon. When executed by at least one processor, the instructions can be configured to cause a computing system to receive a communication via a first application, generate a response based on content of the communication and content stored in association with a second application, and presenting the response.

A computing system can include at least one processor and a non-transitory computer-readable storage medium comprising instructions stored thereon. When executed by the at least one processor, the instructions can be configured to cause the computing system to receive a message associated with a user account; determine a priority based on content of the message; determine a first status associated with the user account; based on the priority and the first status, withhold notification of the message; determine a second status associated with the user account; and based on the priority and the second status, present a summary of the message.

The details of one or more implementations are set forth in the accompanying drawings and the description below. Other features will be apparent from the description and drawings, and from the claims.

### BRIEF DESCRIPTION OF THE DRAWINGS

FIG. 1A shows a wearable device receiving communications while a user who is wearing the wearable device is driving a vehicle.

FIG. 1B shows the wearable device presenting a summary of the communications received in FIG. 1A to the user after the user has exited the vehicle.

FIG. 2 shows an architecture for a wearable device presenting summaries of communications.

FIG. 3A shows a message received by a wearable device.

FIG. 3B shows a calendar application associated with a user of the wearable device.

FIG. 3C shows a response that was generated based on the message and content stored in association with the calendar application.

FIG. 4A shows a wearable device presenting a summary of a communication.

FIG. 4B shows an application opened based on the communication for which the summary of FIG. 4A was presented.

FIG. 5 is a block diagram of a computing system that can perform the methods, functions, and/or techniques described herein.

FIG. 6 is a flowchart showing a method.

FIG. 7 is a flowchart showing a method.

Like reference numbers refer to like elements.

### DETAILED DESCRIPTION

Users of wearable devices, such as smartglasses or smartwatches, can receive communications such as text messages, voice calls, or voicemails. A technical problem with receiving communications at a wearable device is that a limited display on the wearable device can make viewing images, such as lengthy text, difficult. A further technical problem with receiving communications at a wearable device is that the user may be engaged in tasks that make reviewing and/or responding to the communication difficult. A further technical problem with receiving communications at a wearable device is that responding to a communication may involve opening an application, and opening the application on the wearable device may be difficult.

A technical solution to the technical problem of limited display is to generate and present a summary of the communication(s) on the display. A technical solution to the technical problem of the user being engaged in tasks is to compare a priority of the communication(s) to a status of the user and determine whether to present the summary based on the priority and status. A technical solution to the technical problem of responding to a communication involving opening an application is to open, or prompt the user to open, the application. Technical benefits to these technical solutions are the ability to present content of communications within a small display, presenting communications when the communications will be understood and/or acted upon, and/or quickly responding via the application.

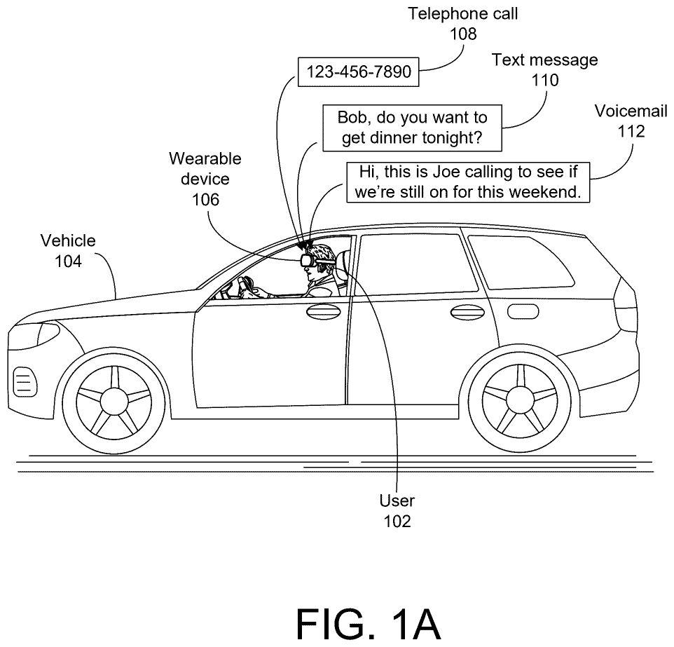

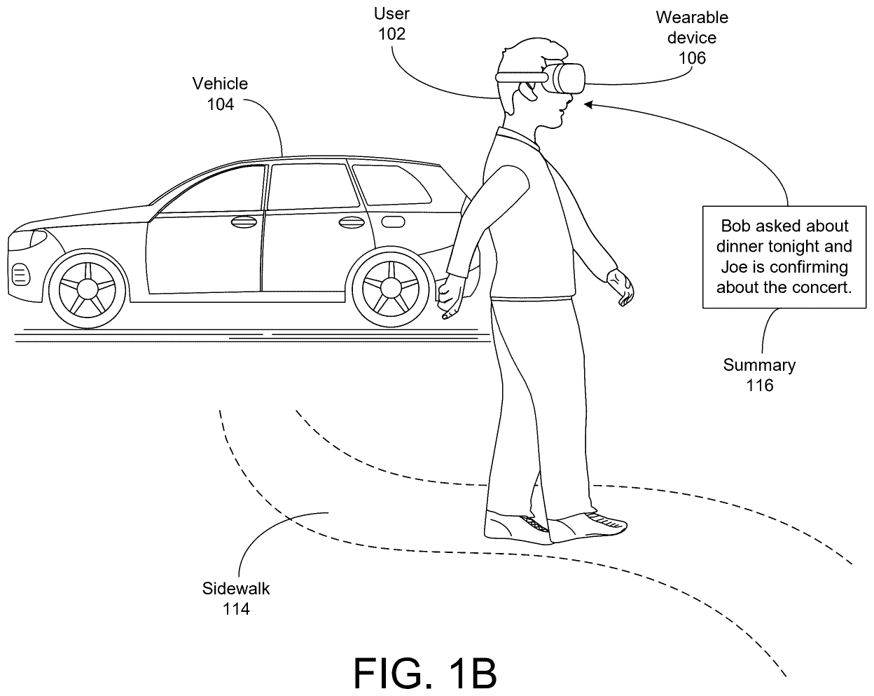

FIG. 1A shows a wearable device 106 receiving communications while a user 102 who is wearing the wearable device 106 is driving a vehicle 104. The user 102 may be logged into a server with a user account associated with the user 102 via the wearable device 106. The user 102 may be driving or otherwise controlling the vehicle 104. Reading, viewing, and/or responding to a message could distract the user 102 and create the risk of a collision or other adverse event.

The user 102 can receive communications via the wearable device 106 while driving the vehicle 104. The communications can also be considered messages. In the example shown in FIG. 1A, the user 102 receives a first communication of a telephone call 108. FIG. 1A shows a telephone number from which the telephone call 108 was received, but does not show content of a telephone call because in the example of FIG. 1A the wearable device 106 did not notify the user 102 of the telephone call 108 and the user 102 did not answer the telephone call 108.

In the example of FIG. 1A, the user 102 receives a second communication of a text message 110. The text message 110 includes textual content, “Bob, do you want to get dinner tonight?” and includes an identifier of a sender of the text message 110. However, the textual content is not presented to the user 102 in the example of FIG. 1A.

In the example of FIG. 1A, the user 102 receives a third communication of a voicemail 112. The voicemail 112 can identify a sender or originator of the voicemail 112. In some examples, the sender or originator of the voicemail 112 is the same as the sender or originator of the telephone call 108 (identified by the telephone number). In some examples, the sender or originator of the voicemail 112 is different from the sender or originator of the telephone call 108. A transcription of the voicemail 112 is, “Hi, this is Joe calling to see if we're still on for this weekend.” The voicemail 112 is not presented to or played for the user 102 in the example of FIG. 1A.

In the example of FIG. 1A, a computing system, which can include the wearable device 106 or a computing system (such as a remote server) in communication with the wearable device 106, determines a priority level of the communications. In this example, the communications include the telephone call 108, the text message 110, and the voicemail 112. In some implementations, the computing system (such as the wearable device and/or a remote server) determines a priority level for each of the communications.

In some implementations, a combined priority level is determined for all of the communications for which notifications and/or summaries have not been presented to the user 102. In some implementations, the combined priority level is at least as high as a priority level of a communication with a highest priority level among communications for which notifications and/or summaries have not been presented to the user 102. In some implementations, the combined priority level is higher than a priority level of a communication with a highest priority level among communications for which notifications and/or summaries have not been presented to the user 102, reflecting an increasing priority level when additional communications have not resulted in notifications and/or summaries.

In some implementations, priority levels are determined for groups of communications that came from a same sender and/or originator. For example, a first group of communications from a first sender can have a first priority level, a second group of communications from a second sender can have a second priority level, and a third group of communications from a third sender can have a third priority level. The priority levels of each of the groups of communications can be based, for example, on content of the communication within the group (such as whether the content refers to events and/or topics that are occurring sooner or later in time, whether the communications request a response) and/or a priority level of the sender (which can be based on whether the user typically responds quickly to the sender).

In some implementations, priority levels are determined for groups of communications that are related to a same topic. For example, a first group of communications with a first priority level can include communications related to plans for a particular evening, a second group of communications with a second priority level can include communications related to a shared budget, and a third group of communications with a third priority level can include communications related to a shared interest. The computing system can determine the priority levels of the groups of communications based on the content of the communications and/or a frequency or latency of previous responses by the user 102 to communications within the group of communications.

In some implementations, priority levels are higher for events and/or topics that are occurring sooner in time and lower for events and/or topics that are occurring later in time.

In some implementations, priority levels are higher for communications that request a response and lower for communications that do not request a response. The computing system can determine whether a communication requests a response by natural language understanding techniques that perform intent recognition to identify a sentiment in in text representing the communication and entity recognition that identifies entities in the communication and extracts important information about the entities. Natural language understanding can include performing lexical semantic analysis to understand the meanings of each of the words in the communication individually, and compositional semantic analysis to disambiguate words within the communication and extract relationships within the communication.

In some implementations, priority levels are based on the content of the communications, such as higher for an injury or event related to a person to whom the user 102 is emotionally or socially close, and lower for less significant events related to persons to whom the user 102 is not emotionally or socially close.

In the example of FIG. 1A, the computing system, which can include the wearable device 106 or a computing system (such as a remote server) in communication with the wearable device 106, determines a first status of the user 102 and/or a status that is associated with the user account. The status can be a quantitative value indicating a likelihood that the user 102 will respond to an interruption of activity of the user 102 and/or stop a current activity of the user 102. The first status can be based on a context of the user 102. The context can be determined based on visual cues such as images captured by one or more cameras included in and/or in communication with the wearable device 106, based on audio signals processed by one or more microphones included in and/or in communication with the wearable device 106, based on location information related to the wearable device 106 (such as a location of the wearable device 106), and/or based on information stored in association with the user account (such as calendar entries), as non-limiting examples. In some implementations, a language model implemented by or accessed by the computing system can generate a semantic description of the context, and the computing system can determine the status based on the semantic description. The computing system can implement and/or access a machine learning model that determines the status based on whether the user 102 or other users respond to interruptions or notifications when in similar contexts, with higher rates of response resulting in a lower status for a given context and lower rates of response resulting in higher status for the given context.

The computing system can compare the priority level of the communication(s) to the first status of the user 102 and/or associated with the user account. In the example shown in FIG. 1A, because the user 102 is driving, which requires a high level of concentration, and the communications are not urgent, the comparison of the priority level of the communication(s) and the first status results in a determination that the communication(s), and/or a summary of the communication(s), should not be presented to the user 102. Accordingly, notification of the communication(s) is withheld from the user 102.

FIG. 1B shows the wearable device 106 presenting a summary of the communications received in FIG. 1A to the user 102 after the user 102 has exited the vehicle 104. After the user 102 has exited the vehicle 104, the user 102 is walking on a sidewalk 114. Walking on a sidewalk requires less concentration than driving a vehicle, and the consequences of making a mistake while walking on a sidewalk are less severe than a mistake made while driving a vehicle. The computing system, which can include the wearable device 106 and/or a computing system in combination with the wearable device 106, can determine a second status of the user 102 and/or associated with the user account. The second status can be different than the first status determined when the user 102 was driving the vehicle 104 and can reflect a lower need for concentration and/or lower risk of distraction.

The computing system can compare the priority value of the communication(s) to the second status. Based on the comparison of the priority value to the second status, the computing system can determine that a notification and/or summary of the communication(s) should be presented to the user 102. Based on the determination that the notification and/or summary of the communication(s) should be presented to the user 102, the wearable device 106 presents a summary 116 of the communication(s) to the user 102. In the example shown in FIG. 1B, the summary 116 includes text, “Bob asked about dinner tonight and Joe is confirming about the concert.” In the example shown in FIG. 1B, the summary 116 is based on the communications shown in FIG. 1A as well as other information associated with the user account, such as a calendar event indicating a concert for the weekend or previous messages referring to the concert.

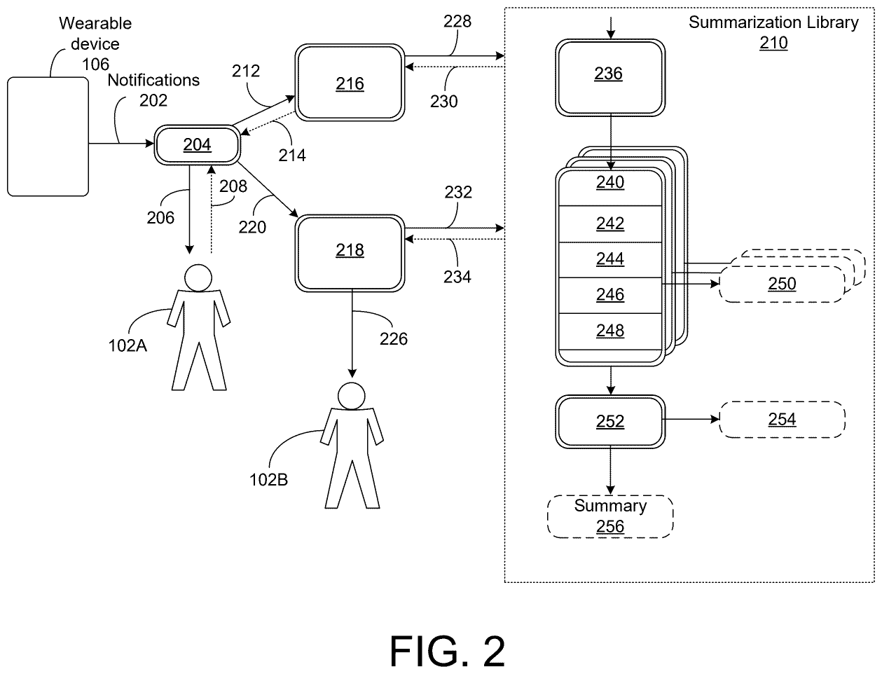

FIG. 2 shows an architecture for a wearable device 106 presenting summaries of communications. The wearable device 106 can be a wearable device such as smartglasses, or a smartwatch that is worn by a user such as the user 102.

A notification pipeline 204 can be implemented by the wearable device 106 and/or a computing system in communication with the wearable device 106. The notification pipeline 204 can implement a listener service. The listener service can receive notifications 202. In some implementations, the notifications 202 include communications and/or messages, such as text messages, telephone calls and/or voicemails. In some implementations, the notifications 202 include notifications of the communications and/or messages that do not include the content of the communications and/or messages.

The notification pipeline 204 can send visual or audible notifications 206 to a user 102A via the wearable device 106. The user 102A is an example of the user 102 at a particular point in time. The notification pipeline 204 can receive an indication(s) 208 that the user 102A has ignored or missed the notifications 206.

The notification pipeline 204 can send an indication 212 of a single notification 202 to a summarization processor 216. The summarization processor 216 can parse notifications and provide input to a summarization library 210. The input that the summarization processor 216 provides to the summarization library 210 can include an individual notification summarization request 228. In response to receiving the individual notification summarization request 228 from the summarization processor 216, the summarization library 210 can send a summarization result 230 to the summarization processor 216. The summarization result 230 can be a summary of the communication and/or message that was the subject of the individual notification summarization request 228.

The summarization processor 216 can send a return notification 214 to the notification pipeline 204. The return notification 214 can include a summary of the notification 202 and/or indication 212.

The notification pipeline 204 can send an indication of multiple missed notification events 220 to a notification digest summary repository 218. The notification digest summary repository 218 can compute, determine, and/or generate a summary representation of multiple missed notifications and present the summary representation to a user in a digestible format. The digestible format may include limited words and/or characters that fit onto the display of the wearable device 106.

The notification digest summary repository 218 can send a multiple notifications summarization request 232 to the summarization library 210. The multiple notifications summarization request 232 can be a request for a summary of multiple notifications, communications, and/or messages for which the user 102 did not receive or read (i.e. ignored or missed) a notification. In some implementations, the multiple notifications included in the multiple notifications summarization request 232 are unrelated in that the notifications came from different sources (such as different user accounts) and/or the content of the notifications relates to different subjects.

In response to sending the multiple notifications summarization request 232 to the summarization library 210, the notification digest summary repository 218 can receive a summary result 234. The summary result 234 is a summary of the notifications included in the multiple notifications summarization request 232.

The notification digest summary repository 218 can send a summary 226 to a user 102B via the wearable device 106. The user 102B can be a user, such as the user 102, at a later time than the user 102A. The summary 226 can be a summary of the multiple missed notification events 220. The summary 116 shown in FIG. 1B is an example of the summary result 234.

The summarization library 210 can summarize individual notifications, messages, and/or communications, and/or can generate summaries of multiple notifications, messages, and/or communications. The summarization library 210 can be included in the wearable device 106, or can be included in a computing system in communication with the wearable device 106, such as a remote server.

The summarization library 210 can include a summarization handler 236. The summarization handler 236 can receive and respond to the individual notification summarization request 228 and/or multiple notifications summarization request 232. The summarization handler 236 can respond to the individual notification summarization request 228 and/or multiple notifications summarization request 232 by selecting and/or calling a summarization provider 240.

The summarization library 210 can include the summarization provider 240. The summarization library 210 can call and/or implement one or more summarization models 250 to generate a summary of the content of the individual notification summarization request 228 and/or multiple notifications summarization request 232. The one or more summarization models 250 can include language models such as large language models.

The summarization provider 240 can perform input preprocessing 242. Input preprocessing can include extracting the content to be summarized. The input preprocessing 242 can be performed on the content of the individual notification summarization request 228 and/or multiple notifications summarization request 232. The summarization provider 240 can perform prompt fine-tuning 244. Prompt fine-tuning 244 can include generating and/or improving prompts for the one or more summarization models 250 to summarize the content of the individual notification summarization request 228 and/or multiple notifications summarization request 232. The prompt can also include a limit on the length of the summary so that the summary will fit into the display of the wearable device 106. The summarization provider 240 can generate the summary 246. Generating the summary 246 can include sending a summarization request to, and receiving the summary from, the one or more summarization models 250. The summarization provider 240 can perform output processing 248. Output processing 248 can include packaging the summary.

The summarization library 210 can include quality-based filtering 252. Quality-based filtering 252 can include sending the summary to a summary quality rater 254. The summary quality rater 254 can determine a quality of the summary, such as by comparing the summary to previous summaries to determine whether the summary meets standards for summarizing a communication. If the summary does not meet standards for summarizing a communication, then the summarization library 210 can instruct the summarization provider 240 perform a new summary. If the summary does meet standards for summarizing a communication, then the summarization library 210 can generate and send a summary 256 to the summarization processor 216 and/or notification digest summary repository 218.

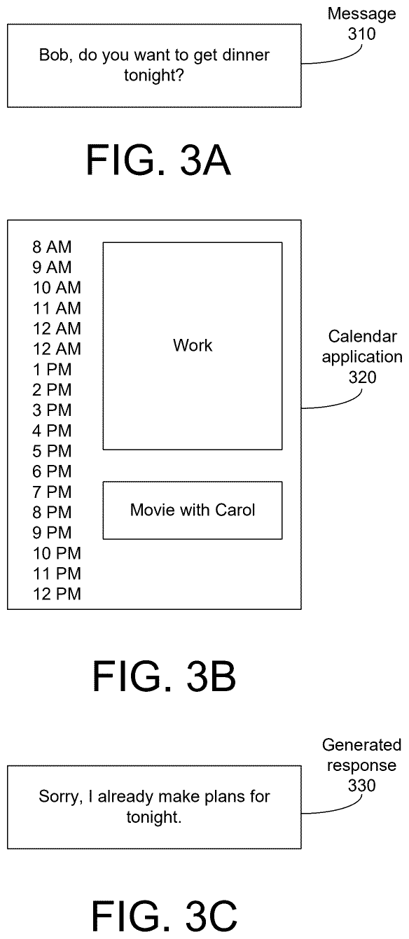

FIGS. 3A through 3C illustrate a process of generating a response based on content of the message and content stored in association with a first application separate from a second application via which the message was received. The response can be generated and/or presented by the wearable device 106 to the user 102 for approval by the user 102

FIG. 3A shows a message 310 received by the wearable device 106. The message 310 can include, and/or be transcribed into, text. In the example shown in FIG. 3A, the text includes, “Bob, do you want to get dinner tonight?” The wearable device 106 can receive the message 310 via the second application, such as a text message application, an email application, or a voicemail application, as non-limiting examples.

FIG. 3B shows a calendar application 320 associated with the user 102 of the wearable device 106. In some implementations, the calendar application 320 is associated with a user account accessed by the user 102 and/or via which the user 102 logs into a server. In some implementations, data stored in association with the calendar application 320, such as appointments, is stored on the wearable device 106. In some implementations, data stored in association with the calendar application 320, such as appointments, is stored on a remote server in association with the user 102 and/or user account. The calendar application 320 is an example of the first application.

As shown in FIG. 3B, the calendar application 320 indicates that the user 102 is busy with work from 8 am to 5 pm, and has scheduled a movie with Carol from 7 pm to 9 pm. Based on the movie with Carol being scheduled from 7 pm to 9 pm, the wearable device 106 and/or a computing system in communication with the wearable device 106 determines that the user 102 has a scheduling conflict and would be unable to meet the request included in the message 310 (to have dinner on the night or evening that the message 310 was sent and/or received).

FIG. 3C shows a response 330 that was generated based on the message 310 and content stored in association with the calendar application 320. The content stored in association with the calendar application 320, which includes the movie with Carol from 7 pm to 9 pm, indicates that the user 102 is not available for dinner with the sender of the message 310. Therefore, the response 330 indicates that the user 102 is not available for dinner tonight: “Sorry, I already made plans for dinner tonight.”

In some implementations, the wearable device 106 presents the response 330 to the user 102 in association with a prompt. The prompt may enable the user 102 to instruct the wearable device 106 to send the response 330 to the sender of the message 310. The user 102 can select the prompt, and/or approve the response 330. The wearable device 106 can respond to the user selecting the prompt and/or approving the response 330 by sending a message and/or text included in the response 330 to the user account that sent the message 310 to the user 102 and/or wearable device 106.

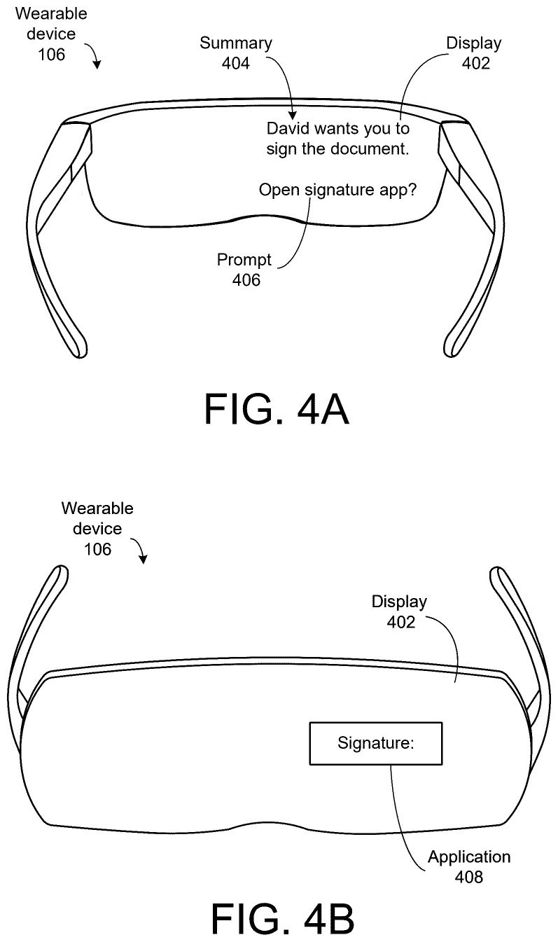

FIGS. 4A and 4B show a summary 404 of a message, a prompt 406 to open an application, and the application 408 presented by the wearable device 106. In some implementations, the wearable device 106 can prompt the user 102 to open and/or approve opening an application based on content of the message and/or summary of the message.

FIG. 4A shows the wearable device 106 presenting the summary 404 of a communication. The wearable device 106 can present the summary 404 on a display 402 included in the wearable device 106. The communication may be a communication received by the wearable device 106. The summary 404 can also be considered a summary of a message. The summary 404 may have been generated by a language model, and/or based on the architecture shown and described with respect to FIG. 2. The message and/or communication can include a request to sign a document. Based on the message and/or communication, the summary 404 includes the text, “David wants you to sign the document.” A summary can be a shortened version of a longer text that highlights main points and/or key information. In some implementations, the summary can include an interpretation of the original text or language. In some implementations, the summary can be, or can include, a condensed version of original text or language. The main point and/or key information highlighted by the summary 404 is the desire of David for the user to sign a particular document.

The wearable device 106, and/or a computing system in communication with the wearable device 106, determines, based on content of the message and/or communication that was summarized in the summary 404, that a signature application would be helpful in responding to the message and/or communication. Based on determining that the signature application would be helpful in responding to the message and/or communication, the wearable device 106 presents the prompt 406 to open the signature application. The wearable device 106 can present the prompt 406 on the display 402. The prompt 406 can be text, such as, “Open signature app?” an icon or image, or a combination of text and an icon or image. The user 102 can select and/or approve the prompt 406 by voice input, gaze input (such as by looking at the prompt 406 for a predetermined period of time), gesture input, or touch input, as non-limiting examples.

FIG. 4B shows an application 408 opened based on the communication for which the summary of FIG. 4A was presented. In the example shown in FIG. 4B, the application 408 is a signature application for which the wearable device 106 presented the prompt 406 based on content of the message and/or communication. The user 102 selected and/or approved the prompt 406. Based on the user 102 selecting and/or approving the prompt 406, the wearable device 106 opened and/or launched the application 408. The wearable device 106 can present the application 408 on the display 402. The user 102 can interact with the application 408 to sign the document referred to in the summary 404.

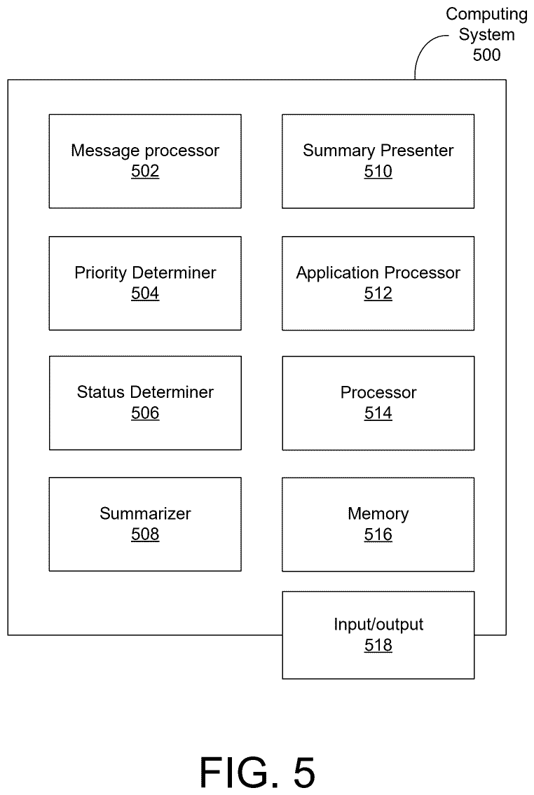

FIG. 5 is a block diagram of a computing system 500 that can perform the methods, functions, and/or techniques described herein. The features of the computing system 500 can be implemented by the wearable device 106, a computing system in communication with the wearable device 106 (such as a remote server), or distributed between multiple computing devices such as the wearable device 106 and a remote server, as non-limiting examples.

The computing system 500 can include a message processor 502. The message processor 502 can process messages and/or communications that are received by the wearable device 106 and/or addressed to a user account associated with the wearable device 106.

The message processor 502 can request a priority determiner 504 to determine a priority level of received messages and/or groups of messages. In some examples, the priority determiner 504 determines priority levels of individual messages. In some examples, the priority determiner 504 determines priority levels of groups of messages. The messages can be included in a same group based on having a same sender or being related to a same topic (based on content included in the messages), as non-limiting examples. In some implementations, the priority determiner 504 determines a highest priority level of messages and/or groups of messages that have not been presented to the user 102 and/or for which summaries have not been presented to the user 102. In some implementations, the priority determiner 504 determines the priority level based on the sender and/or receiver of the message. For example, messages from user accounts for whom the user 102 (the receiver of the message) historically has a high frequency of quickly responding may have higher priority levels than messages from user accounts for whom the user 102 typically responds slowly or not at all. The user history can be stored based on explicit user permission. In some implementations, the priority determiner 504 determines the priority level based on content of the messages, such as messages indicating an important event such as an injury having higher priority levels than messages indicating less consequential events. In some implementations, the priority determiner 504 determines priority levels based on regency of the messages, with more recent messages having higher priority than less recent messages. In some implementations, the priority determiner 504 determines priority levels based on whether content of the messages request a response, with messages requesting a response having higher priority than messages that do not request a response. In some implementations, the priority determiner 504 determines priority levels based on how soon an event referred to in the message is occurring, with messages that refer to events happening sooner having higher priority levels than messages that refer to events happening later. In some implementations, the priority determiner 504 determines a priority level based on a number of messages from the same person, a number of applications via which a same user account sent messages, and/or a number of messages for which the content refers to a same topic, with more messages, more applications via which a user account sent messages, and/or more messages for which the account refers to a same topic causing the priority level to increase.

The computing system 500 can include a status determiner 506. The status determiner 506 can determine a status of the user 102. The status determiner 506 can determine the status of the user 102 based on signals including images captured by cameras included in the wearable device 106 and/or computing devices in communication with the wearable device 106, audio signals processed by the wearable device 106 and/or computing devices in communication with the wearable device 106, and/or a location of the wearable device 106 which may be determined by positioning systems and/or based on calendar information associated with the user 102, as non-limiting examples. The status may indicate a need for the user 102 to not be interrupted, a need to avoid presenting notifications to the user 102, and/or a value to compare the priority level to when determining whether to present a summary to the user 102. For example, when the user 102 is driving a vehicle, the status may have a value that prevents most messages from being presented, when the user 102 is in conversation with another person, the status may have a value that prevents some messages from being presented, and when the user 102 is simply walking or idly sitting, the status may have a value that allows all messages to be presented.

The computing system 500 can include a summarizer 508. In some implementations, the summarizer 508 generates a summary of a single messages and/or communication. In some implementations, the summarizer 508 generates a summary of multiple messages and/or communications. The summarizer 508 can generate the summary based on the content of the message(s) and/or communication(s). The content can include text and/or non-textual content such as one or more images. In some examples, the content can include an address of a file, such as a uniform resource locator (URL), and the content can include content of the file referred to by the address. The summary includes fewer words and/or characters than the original message(s) and/or communication(s), allowing the summary to occupy less display area. In some implementations, the summarizer 508 includes a language model that generates the summaries. In some implementations, the summarizer 508 requests a language model to perform the summaries.

The computing system 500 can include a summary presenter 510. The summary presenter 510 can determine whether to present a summary generated by the summarizer 508. The summary presenter 510 can determine whether to present a summary generated by the summarizer 508 based on the priority level(s) determined by the priority determiner 504 and the status determined by the status determiner 506. In some implementations, the summary presenter 510 determines a threshold priority level based on the status determined by the status determiner 506. The threshold priority level can be higher for tasks that require high concentration levels such as driving. If the priority level satisfies the threshold priority level, such as by meeting or exceeding the threshold priority level, then the summary presenter 510 can present the notification and/or summary of the message and/or communication. If the priority level does not satisfy the threshold priority level, then the summary presenter 510 can withhold the summary and/or notification of the message and/or communication.

The computing system 500 can include an application processor 512. The application processor 512 can launch applications based on content of messages and/or communications. For example, if a message or communications refers to signing a document, then the application processor 512 can launch, and/or prompt the user 102 to launch, a document-signing application. In another example, if a message or communication refers to a song, then the application processor 512 can launch, and/or prompt the user 102 to launch, a music application and play the song referred to in the message and/or application.

The computing system 500 can include at least one processor 514. The at least one processor 514 can execute instructions, such as instructions stored in at least one memory device 516, to cause the computing system 500 to perform any combination of methods, functions, and/or techniques described herein.

The computing system 500 can include at least one memory device 516. The at least one memory device 516 can include a non-transitory computer-readable storage medium. The at least one memory device 516 can store data and instructions thereon that, when executed by at least one processor, such as the processor 514, are configured to cause the computing system 500 to perform any combination of methods, functions, and/or techniques described herein. Accordingly, in any of the implementations described herein (even if not explicitly noted in connection with a particular implementation), software (e.g., processing modules, stored instructions) and/or hardware (e.g., processor, memory devices, etc.) associated with, or included in, the computing system 500 can be configured to perform, alone, or in combination with the computing system 500, any combination of methods, functions, and/or techniques described herein.

The computing system 500 may include at least one input/output node 518. The at least one input/output node 518 may receive and/or send data, such as from and/or to, a server, and/or may receive input and provide output from and to a user. The input and output functions may be combined into a single node, or may be divided into separate input and output nodes. The input/output node 518 can include, for example, a display that presents output such as textual output, a camera, a speaker, a microphone, one or more buttons, a keyboard, and/or one or more wired or wireless interfaces for communicating with other computing devices

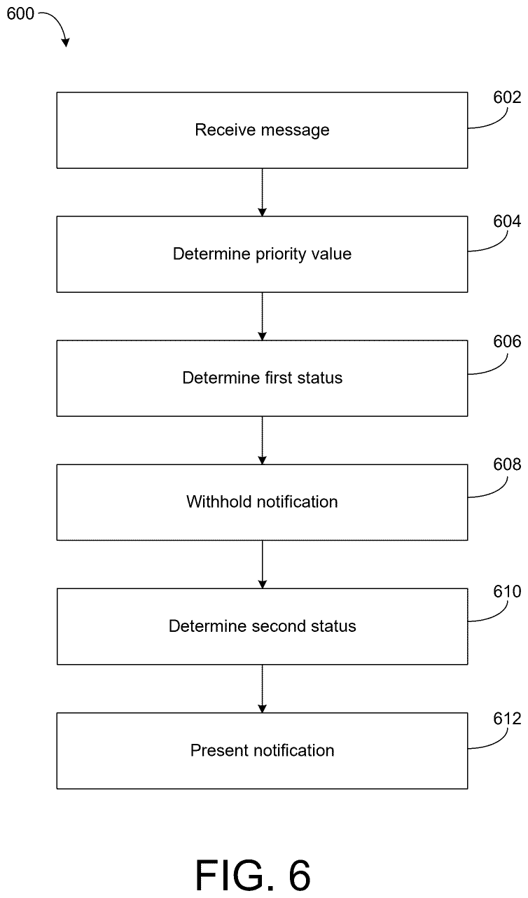

FIG. 6 is a flowchart showing a method 600. The method 600 can include receiving a message associated with a user account (602). The method 600 can include determining a priority, which may be considered a priority value, based on content of the message (604). The method 600 can include determining a first status associated with the user account (606). The method 600 can include, based on the priority and the first status, withholding notification of the message (608). The method 600 can include determining a second status associated with the user account (610). The method 600 can include, based on the priority and the second status, presenting a summary of the message (612).

In some implementations, the method 600 further includes generating a response based on content of the message and content stored in association with a first application separate from a second application via which the message was received. The summary can include the response.

In some implementations, the first status is determined based on at least one image.

In some implementations, the first status is determined based on audio signals.

In some implementations, the message is a first message, the method 600 further includes receiving a second message associated with the user account, determining the priority includes determining the priority based on content of the first message and the second message, and the summary is based on the first message and the second message.

In some implementations, the first message is received via a first application, and the second message is received via a second application that is different from the first application.

In some implementations, the summary includes a prompt to open an application.

In some implementations, the method 600 further includes requesting a language model to generate the summary based on the message, and receiving the summary from the language model.

In some implementations, the method 600 is performed by a wearable device.

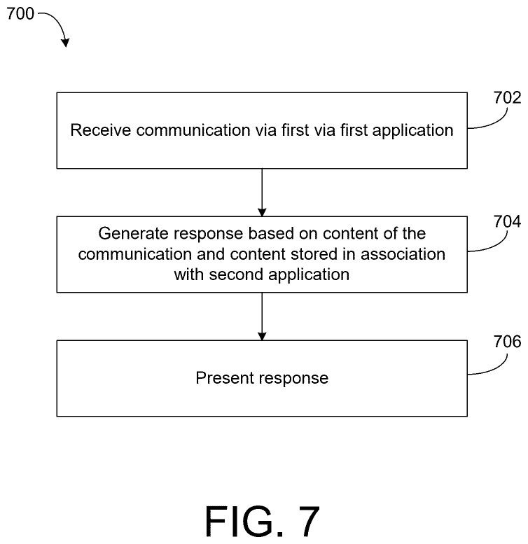

FIG. 7 is a flowchart showing a method 700. The method 700 can include receiving a communication via a first application (702). The method 700 can include generating a response based on content of the communication and content stored in association with a second application (704). The method 700 can include presenting the response (706).

In some implementations, the communication is a first communication; the instructions are further configured to cause the computing system to receive a second communication via the first application; and the response is based on content of the first communication, content of the second communication, and content stored in association with the second application.

In some implementations, the communication is a first communication; the instructions are further configured to cause the computing system to receive a second communication via a third application; and the response is based on content of the first communication, content of the second communication, and content stored in association with the second application.

In some implementations, the method 600 is performed by a wearable device.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the embodiments of the invention.

What is claimed is:

1. A method comprising:
receiving a message associated with a user account;
determining a priority based on content of the message;
determining a first status associated with the user account;
based on the priority and the first status, withholding notification of the message;
determining a second status associated with the user account; and
based on the priority and the second status, presenting a summary of the message.

2. The method of claim 1, further comprising:
generating a response based on:
content of the message; and
content stored in association with a first application separate from a second application via which the message was received,
wherein the summary includes the response.

3. The method of claim 1, wherein the first status is determined based on at least one image.

4. The method of claim 1, wherein the first status is determined based on audio signals.

5. The method of claim 1, wherein:
the message is a first message,
the method further includes receiving a second message associated with the user account,
determining the priority includes determining the priority based on content of the first message and the second message, and
the summary is based on the first message and the second message.

6. The method of claim 5, wherein:
the first message is received via a first application, and
the second message is received via a second application that is different from the first application.

7. The method of claim 1, wherein the summary includes a prompt to open an application.

8. The method of claim 1, further comprising:
requesting a language model to generate the summary based on the message; and
receiving the summary from the language model.

9. The method of claim 1, wherein the method is performed by a wearable device.

10. A non-transitory computer-readable storage medium comprising instructions stored thereon that, when executed by at least one processor, are configured to cause a computing system to:
receive a communication via a first application;
generate a response based on content of the communication and content stored in association with a second application; and
presenting the response.

11. The non-transitory computer-readable storage medium of claim 10, wherein:
the communication is a first communication,
the instructions are further configured to cause the computing system to receive a second communication via the first application, and
the response is based on content of the first communication, content of the second communication, and content stored in association with the second application.

12. The non-transitory computer-readable storage medium of claim 10, wherein:
the communication is a first communication,
the instructions are further configured to cause the computing system to receive a second communication via a third application, and
the response is based on content of the first communication, content of the second communication, and content stored in association with the second application.

13. The non-transitory computer-readable storage medium of claim 10, wherein the computing system includes a wearable device.

14. A computing system comprising:
at least one processor; and
a non-transitory computer-readable storage medium comprising instructions stored thereon that, when executed by the at least one processor, are configured to cause the computing system to:
receive a message associated with a user account;
determine a priority based on content of the message;
determine a first status associated with the user account;
based on the priority and the first status, withhold notification of the message;
determine a second status associated with the user account; and
based on the priority and the second status, present a summary of the message.

15. The computing system of claim 14, wherein the instructions are further configured to cause the computing system to:
generate a response based on:
content of the message; and
content stored in association with a first application separate from a second application via which the message was received,
wherein the summary includes the response.

16. The computing system of claim 14, wherein the first status is determined based on at least one image.

17. The computing system of claim 14, wherein the first status is determined based on audio signals.

18. The computing system of claim 14, wherein:
the message is a first message,
the instructions are further configured to cause the computing system to receive a second message associated with the user account,
determining the priority includes determining the priority based on content of the first message and the second message, and
the summary is based on the first message and the second message.

19. The computing system of claim 18, wherein:
the first message is received via a first application, and
the second message is received via a second application that is different from the first application.

20. The computing system of claim 14, wherein the summary includes a prompt to open an application.
